(19) United States
(12) Patent Application Publication
(10) Pub. No.: US 2008/0313536 A1
(43) Pub. Date: Dec. 18, 2008

(54) Situation Sharing and Viewing

(75) Inventor: Peter S. Larsen, Duvall, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/762,946

(22) Filed: Jun. 14, 2007

(51) Int. Cl. G06F 17/00; G06F 15/00

(52) U.S. Cl. 715/273

(57) ABSTRACT

A system for sharing and displaying information may have a definition tool that allows a user to select a group of information sources and publish the sources as a situation for the user. A display mechanism may be able to collect several situations from various sources and display the situations using various formats to view situations and links between situations. A server system may facilitate communication and sharing data between clients.

### BACKGROUND

Managing information is an enormous challenge in business. There are many sources of information available to a manager or project leader, whose challenge is to filter and analyze the information to manage a project or company. Information sources may include disparate applications, such as document creation software, project scheduling applications, virtual presence applications, email applications, and other sources. Each of the information sources may have a separate mechanism for viewing the information.

Each person on a project team or within a company may have different responsibilities to different groups, projects, or people. An employee may be assigned two or more different projects, or may have some information that is useful for one group, such as a human resources department, and other information that is useful for another group, such as a project team.

### SUMMARY

A system for sharing and displaying information may have a definition tool that allows a user to select a group of information sources and publish the sources as a situation for the user. A display mechanism may be able to collect several situations from various sources and display the situations using various formats to view situations and links between situations. A server system may facilitate communication and sharing data between clients.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a situation and the components that may make up a situation.

FIG. 2 is a diagram illustration of an embodiment showing a bull's eye or concentric timeline view of several situations.

FIG. 3 is a diagram illustration of an embodiment showing a system for situation sharing and display.

FIG. 4 is a flowchart illustration of an embodiment showing a method for publishing a situation.

FIG. 5 is a timeline illustration of an embodiment showing transactions between a situation client, a clearinghouse server, and a display client.

### DETAILED DESCRIPTION

A situation may be any group of data that might be used to define a current or future state of a project or set of tasks. A situation may include a timeline and the status of various items associated with the timeline. An example of associated items may include a document that may define how a process will be performed and a second document that may be the result of the process or task. For each task, certain people or resources may be defined, each of which may have various status items assigned.

A project manager or coordinator may be able to monitor a collective situation by viewing many situations together. In many cases, one situation may have a link, dependency, or other connection with another situation. Such connections may be implied when two situations are displayed or may be expressly made before or after situations are created.

Various displays may be used to aggregate several situations into a single view. In some embodiments, a bull's eye display may be used that has concentric time circles depicting a timeline that radiates from the center of the display. Within each sector of the display, a different situation may be shown with various data and links.

A system with one or more situation generating clients may be coupled with one or more display clients to share information across projects, work teams, or other related groups. In some instances, a user may create two or more different situations that contain information that may be shared for different purposes or with different individuals or groups of people.

The various clients may or may not be arranged with a server device. In some instances, a server may act as a clearinghouse for various clients, while in other instances, a server may act as a repository for the data that may be shared between clients. The clients and server may have various mechanisms for handling updated data and communicating the updated data to various display clients.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

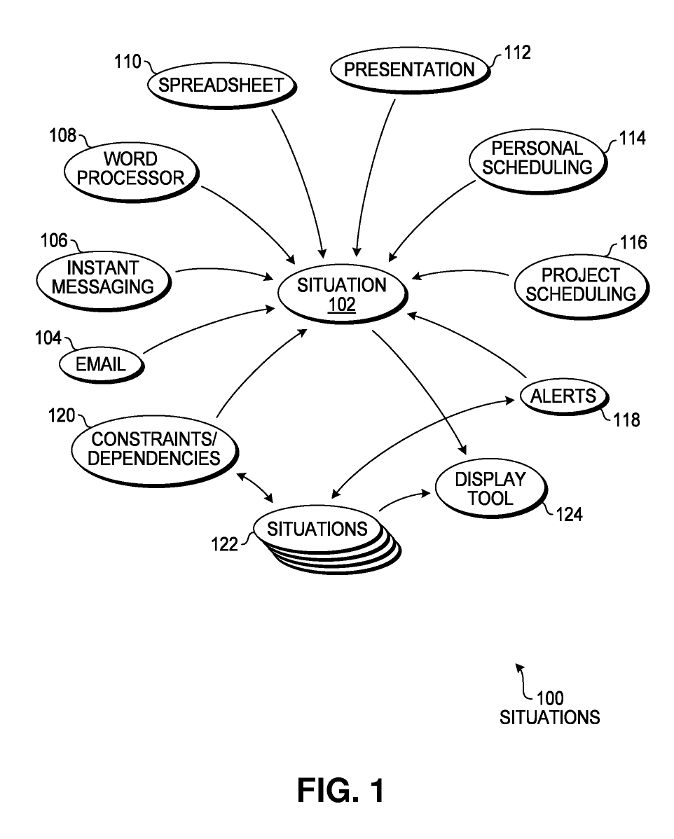

FIG. 1 is a diagram of an embodiment 100 showing an embodiment of a situation. A situation is a term that may be used to describe a current or projected state of a project, person, or other resource. A situation may also include a history of completed tasks, projects, documents, or other items.

In many cases, a situation may be created in relation to or with respect to another project or situation. For example, a person's situation with respect to a project for an employer may include the person's completed, current, and future tasks, milestones, or other project related items. The situation may also include the documents or other resources related to those project items as well as the person's vacation schedule, the availability of resources assigned to the person, and many other factors. In some cases, a person's situation may include dependencies on another person's task or resource.

The same person may have a different situation with respect to a club or service organization, and such a situation may include scheduling and task related information that is different from the work related items discussed above. In some cases, a person may have several situations that may be customized for particular purposes, such as different situations that may be created for each work related project.

A situation may be an aggregation of as many different factors and items as may be tracked. A situation may be displayed with other situations so that a user may be able to view many disparate items in a single static or dynamic view. For example, a project manager may aggregate and view the situations of various resources for a project. The situations may include situations that describe a human resource as well as a non-human resource. By aggregating and linking elements of the various situations, a program manager may be able to track progress, notice potential problems, and adjust resource loading or take other action based on the unified view.

Situations may be created for any type of resource, including human and non-human resources. A human resource may be a person or group of persons who may perform tasks, or use or create resources or items. A non-human resource may be any type of resource that may be used, consumed, have availability, or may be otherwise tracked or monitored. For example, a situation may be defined for a supercomputer device, conference room, company vehicle, production line, or other resource that is shared amongst many users.

A situation may include links or references to documents or other resources that may be created, manipulated, or consumed over time. For example, a situation may include a document, report, or other work product that is developed over the course of a task or in conclusion of a milestone. A situation may include the work product or links to the work product so that a project manager or other person may be able to view the work product during development.

A situation may be shared by peers, subordinates, managers, or any other person or group that may be interested in the situation. For example, a worker may make their situation available to be viewed by other co-workers so that the co-workers may be able to plan their activities around the first worker's schedule or availability. In another example, a manager may share a version of their situation with subordinates. In many cases, a person may have different situations that are shared for other people to view.

The situation is a mechanism by which disparate information may be shared and viewed. In many instances, a situation may contain links or other metadata about related documents or other related sources of information and enable a viewer to browse the metadata or the source data for a related document. For example, a viewer may show a set of timelines with goals and milestones. Information related to a goal or milestone may include metadata or links to related documents. In some cases, a viewer client may enable a user to click on a link and launch a browser or other viewer for viewing a source document.

In the figure, a situation 102 may be composed of email 104 and instant messaging information 106. The information regarding email 104 and instant messaging 106 may include actual email and instant messaging conversations that are related to a milestone or other situation information.

The email 104 and instant messaging information 106 may also include email or instant messaging addresses and presence information. For example, an email or instant message address may be included in a situation so that a situation viewer may include a link to launch an email or instant messaging client so that the user of the viewer client may communicate with a situation owner.

Presence information for a user may also be included in a situation. Presence information may include whether a person is currently online, busy, or some other status. Presence information may be updated in real time and may be viewed through a link to a presence server for an instant messaging or email service.

The situation 102 may include references to or metadata relating to various documents, which may include word processor documents 108, spreadsheet documents 110, presentation documents 112, and other project related information such as databases, project developed software, analysis results, or other information.

The situation 102 may include information from various scheduling databases, including personal scheduling 114 and project scheduling 116. A personal scheduling system may be a personal calendar that has appointments, travel, meetings, vacations, and other information relating to a person's personal schedule. A project schedule may include project related activities, milestones, goals, events, timelines, dependencies, and other related data. In many embodiments, a project schedule may form a backbone of a specific situation, with other forms of information being related to various elements of a project schedule.

Constraints or dependencies 120 may also be part of the situation 102. A constraint or dependency may be defined for any item within the situation 102 and may also include items from another situation. For example, a project schedule item may be dependent on the availability of a person's time based on their personal schedule. A dependency may be created between two or more different documents or between a document and another resource.

Constraints or dependencies 120 may be created in one situation 102 and relate to an item in another situation 122. For example, a person's work product may be dependent on the work product of another person, and the second person's work product may be available through the second person's situation.

Likewise, alerts 118 may be conditional warnings or triggers that may be based on other situations 122 or events or conditions within the situation 102. An alert 118 may be created to bring attention to an event or condition.

The situation 102 and other situations 122 may be rendered using a display tool 124 that may display one or more situations simultaneously. In many embodiments, several situations may be displayed with various levels of detail and in a manner that may allow interaction with the underlying documents or details that make up a situation.

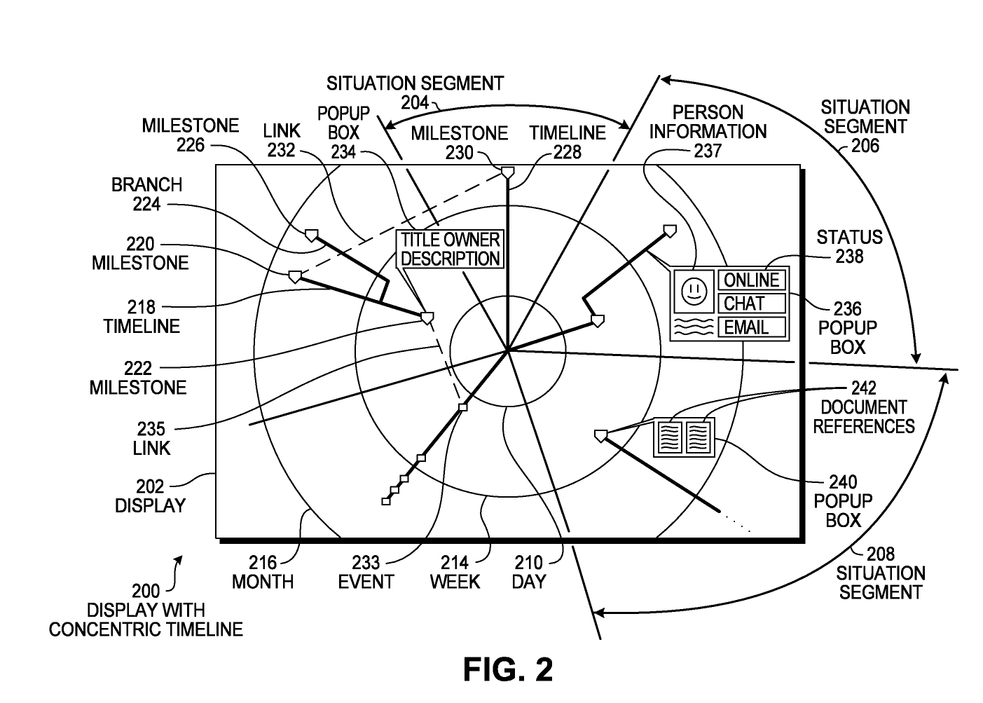

FIG. 2 is a diagram of an embodiment 200 of a display with concentric timeline. The embodiment 200 is merely one way to display multiple situations. Within the display are situations that include project scheduling information with respect to a timeline, various links between timeline elements, and details or supporting information for various elements. Other embodiments may use different mechanisms to convey the information presented to a user. In many cases, a situation may be throttled or filtered to show specific types of data and such data may be further sorted or filtered based on the timeline. For example, more detailed information may be included for events or elements that are in the near timeframe while less detailed information may be included in distant timeframe.

The embodiment 200 illustrates a display 202 with several situations. Each situation may be displayed in a sector or segment, such as those illustrated as segments 204, 206, and 208. Other situations have similar segments. The timeline for the display 202 may be illustrated as concentric rings showing the day 210, week 214, and month 216 timeframes.

The display 202 illustrates a bull's eye or concentric ring display of timeline based information. Each situation or timeline radiates from the center of the display, which may be a first point in time for the timeline. Each concentric ring around the center may represent a period in time. In the embodiment 200, the timeline is displayed as non-linear, with each successive ring depicting a day 210, a week 214, and a month 216 subsequent from the time depicted as the center point.

The non-linear timeline may enable more space and thus more detail to be illustrated in the short time frame and less detail to be illustrated in the later timeframe. In many embodiments, a user may be able to scroll the timeframe to view a specific day's activities in the center ring of the display. A user may also be able to select different types of non-linear timelines or adjust the degree of non-linearity. In some embodiments, a linear timeline may be used, where each circle may represent consecutive units of time.

In embodiment 200, each situation is represented by a timeline. For example, timeline 218 may have an ending milestone 220 and a beginning milestone 222. The timeline 218 may also include a branch 224 with another milestone 226. Similarly, a timeline 228 is illustrated as having a beginning milestone in the past and a continuing timeline until milestone 230.

A link 232 is shown between milestones 220 and 230. The link may be a dependency or constraint defined in one of the two situations or some other mechanism. In some cases, links may also be defined by analyzing several situations and finding common points or implied dependencies. Another example of a link 235 may be between the event 233 and the milestone 222.

The display 202 may include references to metadata or links to supporting or related documents. For example, a popup box 234 may include the title, owner, and a description of the milestone 222. Through the popup box 234, a user of the display 202 may be able to browse detailed information about certain objects on the display. In one embodiment, a user may click on an element, such as milestone 222, to have additional information displayed in the form of the popup box 234.

The popup box 234 may be statically displayed or may be dynamically displayed in response to a user action. Such user action may be clicking on the milestone 222, mousing over the milestone 222, selecting a filter that includes the popup box 234 or its contents for display, or some other mechanism.

Other popup boxes 236 and 240 may display other information about a situation. Popup box 236 may illustrate some personal information 237 that may include status or other presence information 238 about a person. The person referenced in popup box 236 may be an owner or participant in an element of the situation, the person who created or owns the situation, or some other person as defined in the situation.

In many instances, a situation may contain a link to another source for some information. For example, the presence or status information 238 may be obtained from a presence server while the situation may be obtained from a situation server or directly from a peer device that shares the situation. When the presence or status information 238 is displayed, a viewing client may communication with a presence server to obtain up to date or real time presence information.

The popup box 240 may contain document references 242. The document references 242 may include metadata, summary information, or other data concerning the documents referenced by the document references 242. In some embodiments, a viewing client may include a link to actual versions or copies of documents referenced. A user of such a viewing client may be able to display the contents of the documents using a viewer or a copy of the application used to create or edit the document.

In many instances, permission settings may be used to allow or disallow certain functions of a document. For example, a document may be set so that a viewing client may enable viewing but not editing of a document. Such settings may be set within a situation when the situation is shared to another person. In some such cases, different settings may be defined for each different user of the situation. For example, users within a project team may be given read and write permissions while other users may be given read permissions but not write permissions.

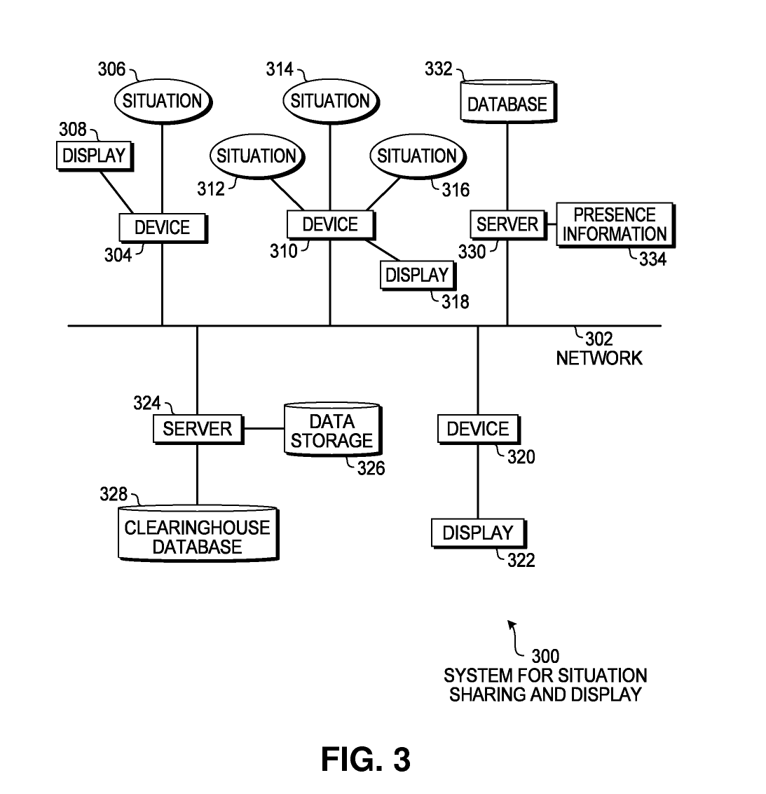

FIG. 3 is a diagram of an embodiment 300 showing a system for situation sharing and display. Embodiment 300 may be network of devices, each of which may have one or more situations that may be shared. In some cases, a server may facilitate the interaction between devices, and a second server may be used to supply various parts of the situation. Each device on the network may also have a display client that is able to display one or more situations from the other devices.

In many embodiments, a situation may be created by a user of a particular device. The situation may be targeted for a specific purpose or to be shared with another specific user. The situation created on a device may have links or relationships with files, data, or other items on the device or items that are accessible from the device.

Embodiment 300 shows a network 302 that has several devices 304, 310, and 320. Each device may have one or more situations. For example, device 304 has situation 306, while device 310 has situations 312, 314, and 316.

Each of the situations may be contain information that may be shared with a viewer or display client. Device 304 has a display client 308, as does device 310 with display client 318 and device 320 with display client 322. Each display client may be capable of locating situation information and displaying one or more situations simultaneously or separately.

Different embodiments may have different methods for sharing situations with viewing or display clients.

In some embodiments, a peer to peer architecture may enable one device to share or host a situation with another device. In a peer to peer architecture, one device may operate a display client that communicates with a situation host that shares a situation. In many such embodiments, the communication may occur directly between the device hosting a situation and the device having the display client.

A peer to peer architecture may use a push or pull method for retrieving current information. A push method may involve the device hosting the situation to notify the device hosting the display of any updates or changes to the situation and transfer the updated information. A pull method may involve the display device contacting the situation host to determine if any information has been updated. If there is updated information, the display device may request the updated information or may be capable of retrieving the information directly.

A peer to peer architecture may be advantageous in embodiments where there are a limited number of situations and viewers operating or where the updates of situations are done infrequently. Since each viewer or display client may contact each situation host multiple times, each device, both situation host and display client, may make or receive multiple requests of the other devices. As the number of such requests rise, the network traffic and computing overhead may rise dramatically.

A version of a peer to peer architecture may include a server that acts as a clearinghouse. A clearinghouse server may receive a notice when a situation is available for sharing and maintain a list of such situations. A viewer or display client may reference the clearinghouse server, browse a list of available situations, and select a situation to display. The clearinghouse server may send information to the display client so that the display client may communicate with the situation host to retrieve situation information.

A server device 324 may maintain a clearinghouse database 328 that includes information about each situation that is available for sharing. When a situation is created, the situation may include permission settings that may enable specific users or groups of users to have limited or full access to the situation. Such permission settings may be used by a clearinghouse database 328 to make a situation available to a viewing or display client that is browsing the list of situations.

For example, a situation may be published and listed in the clearinghouse database 328 with specific permission settings. The permission settings may permit a first user read only access to the situation, a second user may have read and write access to the situation, and a third user may have no access. When the first and second users access the clearinghouse database, the users may browse a listing for the situation and be able to select and view the situation. The third user may browse the clearinghouse database 328 but not be able to view the situation. In some instances, the third user may detect that the situation is listed but may not be able to select and view the listing.

Another architecture may be a centralized server architecture. In a centralized server architecture, the server 324 may maintain a data storage system 326 that may store and share situations created by various other devices, such as devices 304 and 310. A viewing or display client may contact the server 324 and retrieve one or more situations to view through the server 324 and data storage 326 without contacting the situation hosts.

In such a centralized server architecture, a situation may be published to the server 324 and made available for sharing. Multiple viewing clients may retrieve situation information from the server 324 rather than each viewing client individually retrieving situation information from the situation host. A centralized server architecture may be useful to reduce the burden of a situation host from having to service many requests from multiple viewing clients.

Such an architecture may handle updated situation information by sending updates from each situation host to the server 324 on a periodic basis, either by the server 324 periodically querying a situation host or by the host notifying the server 324 when the situation data is stale or has been updated. When an update is available, the server 324 may notify a viewing client, or the viewing client may periodically query the server 324 for updates.

In some centralized server architectures, a centralized server 324 may provide a viewing service that is accessed through a browser or other application operating on a client device. In such an architecture, the centralized server 324 may have access to data making up a situation and transfer an image or other representation of the situation to a display or viewing client.

A situation may be published with copies of documents and other related data. For example, a situation published in a centralized server architecture may include documents, project data, personal data, and other information.

In many embodiments, a situation may be defined so that a display client may be able to retrieve information related to a situation by going to the source of the information. For example, a situation may reference a document that may be available through a shared file system, which may be located on a database 332 connected to server 330. A link or pointer within a situation may enable a display client to access the referenced document directly through the shared file system and avoid communicating with the situation host with respect to the document.

Some information, such as presence information, may be updated in real time. A presence information service 334 operating on server 330 may be referenced by a viewing or display client and the real time data may be displayed within a viewer.

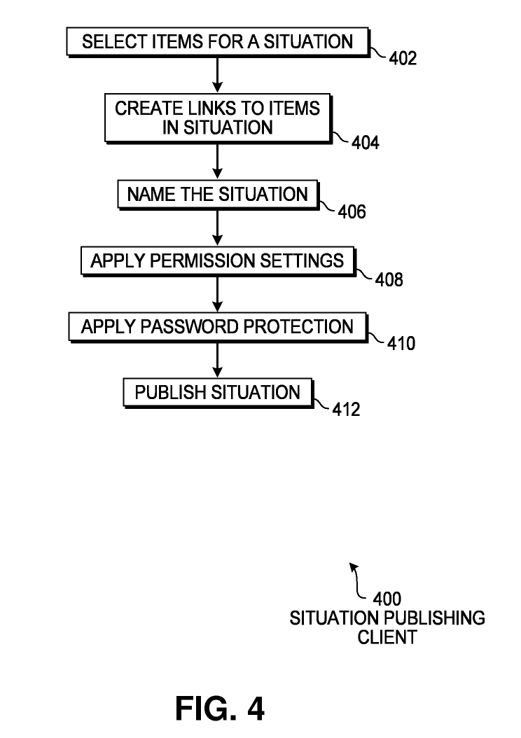

FIG. 4 is a flowchart illustration of an embodiment 400 showing a method for publishing a situation. Embodiment 400 is merely one method by which a situation may be created and made available for a viewing client to use.

Items may be selected in block 402 to be added to a situation and links to some items in the situation may be created in block 404. In some embodiments, a user interface may enable a user to select items in a file system, directly within certain applications, or through any other mechanism. A situation creation application may be used to consolidate various items into a situation.

The situation may be named in block 406 and permission settings applied in block 408. In some embodiments, a situation may have permission settings applied that define which users or devices may view, manipulate, change, or have different access to the situation. A permission setting may define which users or devices may be able to detect that the situation is available for sharing. Each embodiment may have various permission settings and methods for applying the settings.

In some cases, a set of permission settings may be made in conjunction with a server device that may facilitate interaction between the situation host and a viewing or display client. For example, a clearinghouse server or centralized server architecture may maintain a list of registered users of viewing clients against which permission settings may be set.

Password protection may be established in block 410. Password protection may be defined in any useful manner. In some cases, a password may be established to view or access the situation. In other cases, password protection may be established to perform certain tasks or access groups or individual components of a situation. For example, password protection may be established to edit a specific document. In another example, password protection may be used to restrict a user's access to view a specific type of documents referenced in a situation.

The situation may be published in block 412. In some instances, a publication process may involve notifying a specific viewing client or group of viewing clients that the situation is available. In other instances, the publication process may involve communicating with a server device for listing the publication as available and, in some cases, transferring part or all of the situation information to the server.

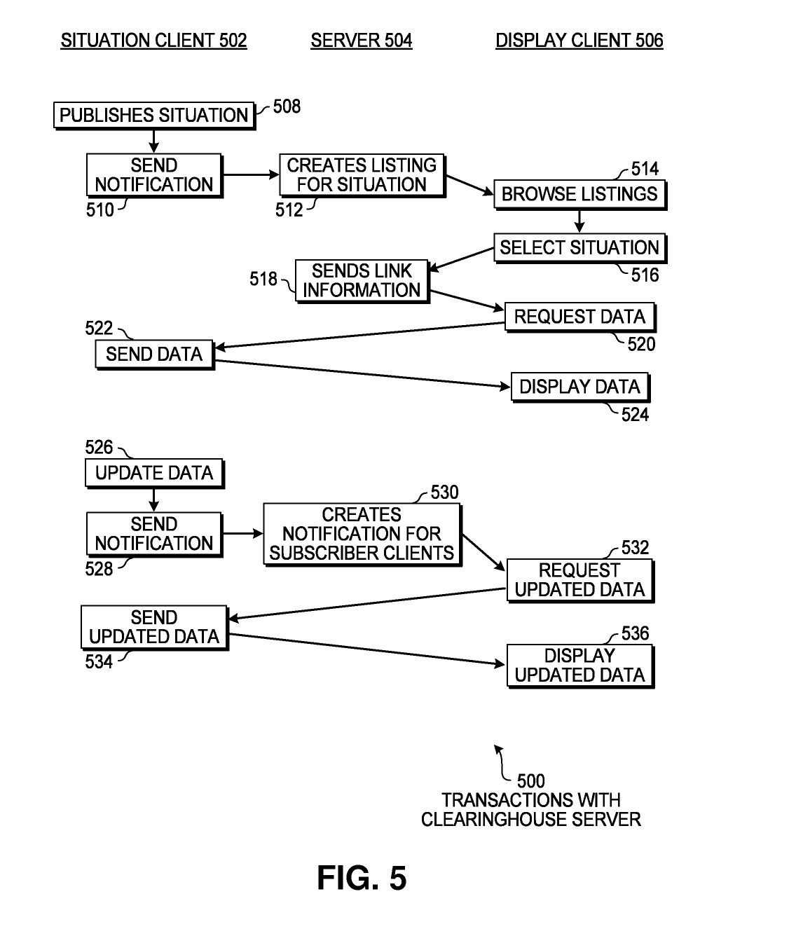

FIG. 5 is a timeline illustration of an embodiment 500 showing interaction between a situation client 502, a server 504, and a display client 506. Embodiment 500 illustrates a clearinghouse server interaction between the two types of clients. Embodiment 500 includes a method for establishing a first view of situation data as well as updating the data.

The situation client 502 may publish a situation in block 508 and send a notification to the server 504 in block 510. The server 504 may create a listing for the situation in block 512 which may be viewed by the display client 506 when browsing situation listings in block 514. The server 504 may contain listings of published situations from many different situation clients. The server 504 may facilitate finding and selecting situations to view by maintaining a centralized list of available situations.

The server 504 may apply permission settings to the list of situations. For example, a user of a viewing or display client 506 may be able to browse listings of situations for which the user has permission, and the server 504 may hide or disable listings for situations for which the user does not have permissions.

The display client 506 may select a situation in block 516 and notify the server 504 of the selection. The server 504 may send link information in block 518 that may enable the display client 506 to request data in block 510 from the situation client 502. The situation client 502 may send situation data in block 522 so that the viewing client 506 may display the situation data in block 524.

The situation client 502 may update data in block 526 and send notification in block 528 to the server 504. The server 504 may create a notification for the subscriber clients in block 530, which may trigger the display client 506 to request updated data in block 532. The situation client 502 may send updated data in block 534 which is displayed by the display client 506 in block 536.

Embodiment 500 uses a clearinghouse server to maintain a list of available situations from which a display client may browse and select one or more situations to view. After selecting a situation to view, the viewing or display client may contact the situation client to download situation information. Other architectures, including peer to peer and centralized server architectures, may have different steps or mechanisms for making situations available, selecting situations, and downloading situation information.

In embodiment 500, updates to situation data may be performed through a notification system that uses the server 504. Since each display client 506 may have selected a situation through the server 504, the server 504 may maintain a database of display clients and the selected situations. The server 504 may notify each display client 506 as each update to a situation occurs or may consolidate the update notifications for multiple situations into a single notification.

Other embodiments may have different architectures and different mechanisms for communicating between situation clients and display clients. The embodiments presented herein are merely examples of ways to implement an embodiment but should not be considered limiting.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a plurality of sets of sharable information comprising a situation, each of said situations comprising:
at least a portion of a timeline;
a reference to at least one person having a first relationship to said timeline; and
a reference to at least one document having a second relationship to said goal; and
displaying said plurality of sets of sharable information with respect to said timeline in a graphical format.

2. The method of claim 1, said timeline being a nonlinear timeline.

3. The method of claim 1, said graphical format comprising a bulls eye format.

4. The method of claim 1 further comprising:
defining a link between a first goal with a second goal; and
displaying said link within said viewable format.

5. The method of claim 1, said reference to a person comprising at least one of a group composed of:
an email address;
an instant messaging address;
an instant messaging presence; and
a reference to a group of persons.

6. The method of claim 1, said graphical format comprising at least one interactive link adapted to display at least a portion of said document.

7. A computer readable medium comprising computer executable instructions adapted to perform the method of claim 1.

8. A method comprising:
selecting a set of sharable information comprising a situation, said situation comprising:
a goal being related to a timeline, said timeline being defined in a first application;
a first reference to at least one person having a first relationship to said goal, said first reference being defined in a second application; and
a second reference to at least one document having a second relationship to said goal, said second reference being defined in a third application;
labeling said set of sharable information; and
making said set of sharable information available over a network for display and updating.

9. The method of claim 8 further comprising:
transmitting said set of sharable information to a server.

10. The method of claim 8, further comprising:
updating a portion of said sharable information using at least one of a group composed of said first application, second application, and third application;
receiving a request for said a portion of said sharable information; and
transmitting said portion of said sharable information.

11. The method of claim 10, said request coming from a server.

12. The method of claim 10, said request coming from a client device adapted to display at least a portion of said set of sharable information.

13. The method of claim 8, further comprising:
updating a portion of said sharable information using at least one of a group composed of said first application, second application, and third application;
determining that said portion of said sharable information has been updated; and
transmitting said portion of said sharable information over said network.

14. The method of claim 13 further comprising:
transmitting a notification based on said determining; and
receiving a request for said portion of said sharable information.

15. The method of claim 13 further comprising:
receiving a request for update from a remote device; and
transmitting said portion of said sharable information to said remote device over said network.

16. A computer readable medium comprising computer executable instructions adapted to perform the method of claim 8.

17. A system comprising:
a first client having a first application, a second application, a third application, and a fourth application, said fourth application adapted to:
select a set of sharable information comprising a situation, said situation comprising:
a timeline, said timeline being defined in said first application;
a first reference to at least one person having a first relationship to said goal, said first reference being defined in said second application; and
a second reference to at least one document having a second relationship to said goal, said second reference being defined in said third application;
label said set of sharable information; and
make said set of sharable information available over a network for display and updating;
a second client adapted to:
receive a plurality of said sets of information; and
display said plurality of said sets of information with respect to said timeline.

18. The system of claim 17 further comprising:
a server adapted to:
receive said set of sharable information from said first client; and
transmit said set of sharable information to said second client.

19. The system of claim 17 further comprising:
a server adapted to:
receive a notification from said first client, said notification being created as a result of at least one update from at least one portion of said set of sharable information; and
transmit at least a portion of said notification to said second client.

20. The system of claim 17 said second client being further adapted to:
download said set of sharable information from said first client.
